(19) United States
(12) Patent Application Publication
(10) Pub. No.: US 2019/0142125 A1
(43) Pub. Date: May 16, 2019

(54) EXTERNAL FRAME LUGGAGE WITH FOLD-OUT COMPUTER CASE

(71) Applicant: 12 Gauge Ideas LLC, Pinehurst, NC (US)

(72) Inventors: Kelly Lynn McAlister, Altamonte Springs, FL (US); Alexander Otto Jacoby, Pinehurst, NC (US)

(73) Assignee: 12 Gauge Ideas LLC, Pinehurst, NC (US)

(21) Appl. No.: 15/812,019

(22) Filed: Nov. 14, 2017

(51) Int. Cl. A45C 13/04; B62B 3/10; A45C 5/03; A45C 5/14; A45C 13/36; A45C 13/26

(52) U.S. Cl. CPC A45C 13/04; B62B 3/10; A45C 5/03; B62B 2205/10; A45C 13/36; A45C 13/262; B62B 2202/24; A45C 5/143

(57) ABSTRACT

The present invention is a piece of luggage with an external frame with a fold-out computer case for use through an X-Ray machine.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to luggage. In particular, it relates to a piece of luggage having an external frame and a fold-out computer case for use through X-ray and other inspection machines.

### Description of Related Art

The use of luggage (often called trolley case or wheeled totes) in airline travel has become quite prevalent. Such luggage is normally rectangular in shape with four corners to the luggage. In order to hold their shape, manufacturers of such luggage utilize internal or external frames. These frames must be substantial enough to deal with heavy loads and strains put on the soft parts of the luggage. They must also protect the luggage from abuse such as dropped luggage or the heavy handling the luggage goes through during loading and unloading on a plane.

A number of different frame types have been developed. The internal frames tend to restrict the amount of space that's available to the user. The external frames free up internal room, however, they tend to be heavier than internal frames and as such are not utilized very often. They all have trouble with other than straight line movement and are difficult to maneuver outside the straight line.

Another problem with luggage and travel is newer requirements to make laptops openly accessible to inspection as one enters the airport security area. They are required to lay flat in a case and not hidden inside the regular luggage. However, carrying them separately means trouble carrying them or exceeding the number of pieces allowed on board, while putting them in the luggage means digging them out while in line at security then stowing them back in the luggage afterwards. There is tremendous need for improved external frames for luggage as well as better ways of traveling with a laptop or other electronic device through security at an airport.

### BRIEF SUMMARY OF THE INVENTION

The present invention relates to the discovery of a new type of external frame which easily adapts to a soft rectangular luggage piece and that has a fold down portion allowing both a laptop case and the luggage to lay flat on a conveyor while still connected. In addition, the laptop case can easily be removed with one hand and there is also room for an additional accessory case which also can be removed. Another embodiment, has wheels which roll perpendicular to the regular wheels wherein some or all of the wheels are removable for easy replacement or to aid in fitting in tight spaces.

Accordingly, in one embodiment, there is a luggage article having a case portion having a backside, opposing front panel, and four corners comprising a pivotable frame pivotally connected to the case portion comprising:
a) a pivot frame connection panel;
b) main wheels mounted on a wheel assembly;
c) a collapsible two-arm luggage handle and two-arm luggage handle frame; and
d) one or more removable small bags mounted in between the two-arm luggage handle frame.

### BRIEF DESCRIPTION OF THE DRAWINGS

FIG. 1 is an exploded view of the luggage of the present invention.

FIG. 2 is a top angled perspective view of the luggage of the invention.

FIG. 3 is a perspective view of the external frame laid open on a security X-ray belt with both case and laptop case laying flat on the belt.

FIG. 4 is a perspective view of the perpendicular moving side wheels.

FIG. 5 is a view of the removable main wheels of the invention.

FIG. 6 is a perspective view of a pivot frame.

FIG. 7 is a perspective view of a pivot frame with cases attached.

FIG. 8 is a perspective view of an alternative embodiment and the frame of FIG. 6.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to the terms “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “luggage” refers to soft sided or hard sided luggage trolley style with a rigid form essentially rectangular in shape for holding clothes, as shown in the Figures. The luggage of the invention has wheels and a tote handle with two arms, especially as shown in the Figures.

As used herein the term “case portion” refers to the portion of the luggage holding clothes and other items other than the bags attached to the pivotable frame as defined herein.

As used herein the term “corners” refers to the four corners of the case portion of the luggage, as can be further seen in the Figures which follow.

As used herein the term “rigid single-piece external back panel” refers to an optional single molded metal or plastic type panel which adds rigidity to the otherwise flexible case portion of the luggage. In one embodiment, the plastic is a polymer resin which is utilized to manufacture the panel. The panel can have four projections that cover the corners of the case and substantially flat panel that covers the bottom of the case, as shown in the Figures. In one embodiment, the corner covers are separate from the back panel.

As used herein the term “pivotal frame” refers to use of a generally rectangular external frame in supporting the case portion of the luggage it is roughly the same length and width of the case portion. The frame pivots, as noted below, to allow the case portion and the small bag portion to both lay flat on the same level flat surface like the belt before X-ray in an airport. In one embodiment, it is made of aluminum or other rigid material.

As used herein the term “pivot frame connection panel” refers to a rigid panel made of plastic, metal, or the like which is part of the pivot frame and can attach to the external back panel or to the case. In one embodiment, the attachment is by a clip or lock at the end opposite the pivot end of the pivot frame.

As used herein the term “wheels on a wheel assembly” refers to main wheels, which can be quick release wheels, which attach to the pivot frame and, in one embodiment, via a wheel axle. The wheel axle is then pivotally mounted to the bottom side of the case portion via a pivot mount. One version is shown in the Figures. Also attached to the wheel assembly, are feet on each side which are capable of aiding in standing the luggage up on its bottom. Perpendicularly mounted secondary wheels (e.g. Barrel) or slides (perpendicular to the travel of the main wheels) aid the user of the luggage in turning the luggage in directions other than straight in the direction of travel of the main wheels.

As used herein the term “collapsible two-arm luggage handle” refers to a collapsible two-arm luggage handle with a two-arm luggage handle frame built into the pivot frame. Such devices are well known in the art and one example is shown in the Figures.

As used herein the term “small bags” refers to smaller bags which will fit in between each of the upright arms of the pivot frame. In one embodiment, one of the bags is a laptop bag which allows one to lay the case and laptop bag flat on the same surface at the same time, as shown in the Figures. The size of the small bags can be small or large but generally is of a size that is positioned inside the pivot frame and can extend between at least 2 paralleled sides of pivot frame.

### DRAWINGS

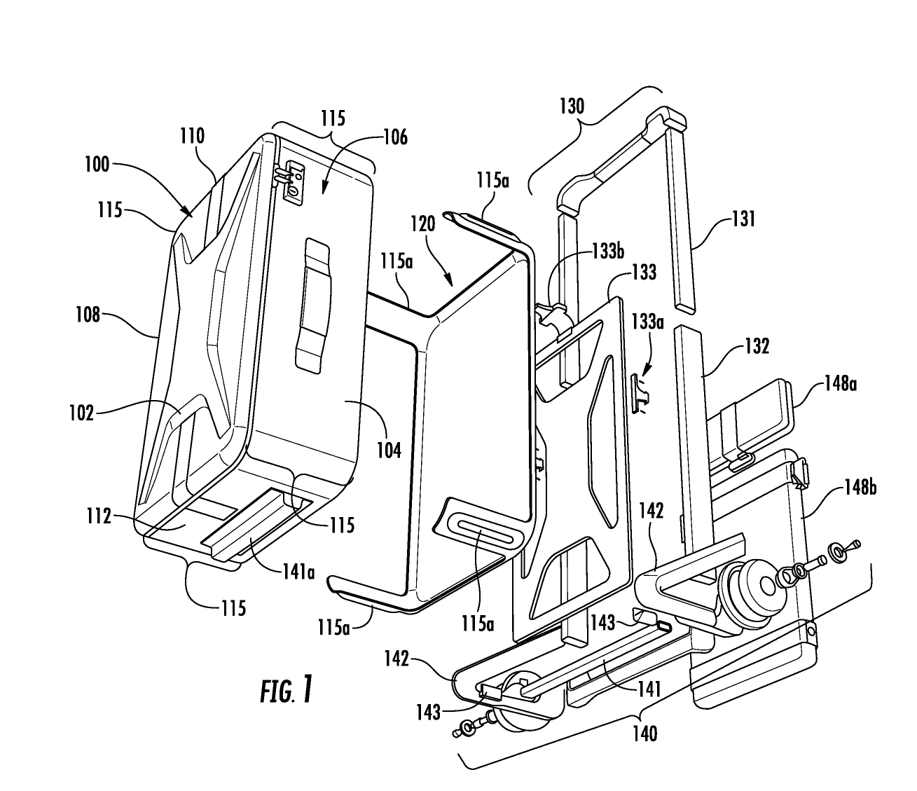

Now referring to the drawings, FIG. 1 is an exploded view of an embodiment of the present invention luggage. Case 100 includes a plurality of panels and is designed to enclose an internal volume for carrying articles of the user. The case can be soft or hard sided. Front and back opposing panels 102 and 104, opposing side panels 106 and 108, and top and bottom panels 110 and 112 collectively form the rectangular case portion. The formation of the case creates four corners 115. In this embodiment, an optional external rigid single piece external back panel 120 substantially covers the back panel 104 and corners 115 with projections 115a as shown in subsequent Figures. The corner covers can be separate from the panel 120.

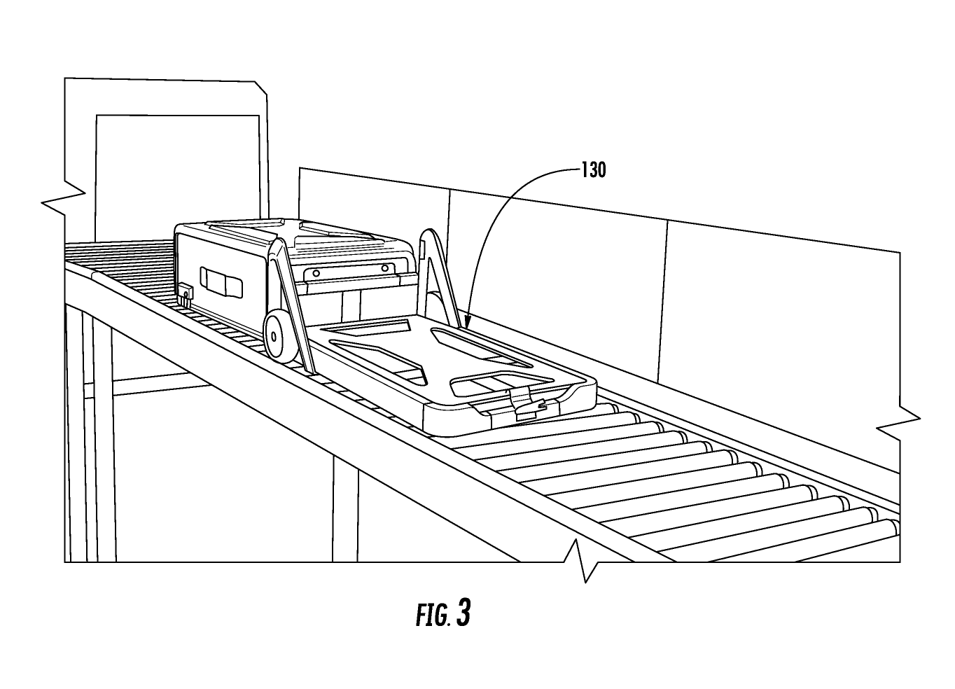

The rectangular pivotal frame 130 consists of several parts. The collapsible two-arm luggage handle 131 slides in and out of two-arm luggage handle frame 132. The pivot frame connection panel 133 is attached between the two-arm upright rectangle pivot frame arms via clips 133a. The connection panel 133 with removable locks on the external back panel 120 utilizes locking clip 133b. A wheel frame assembly 140 is shown without wheels attached and consists of handle or grab bar 141, feet 142, and side sliders (or wheels) 143. The pivot frame pivots by placement of wheel axle 141 into pivot cylinder 141a which allows the pivot frame 130 to pivot and lay flat when the case 100 is laying flat, as shown in FIG. 3.

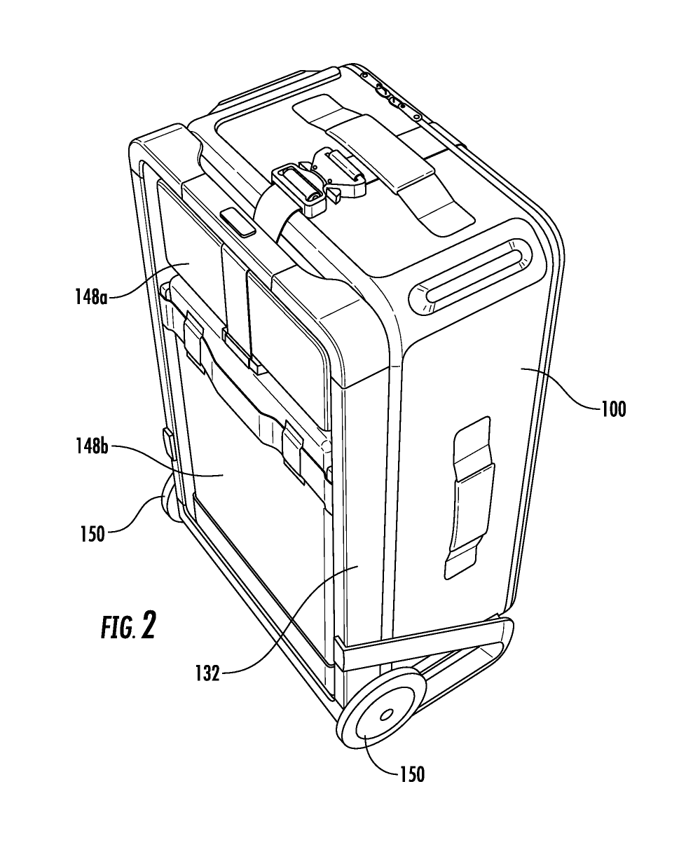

In this view, two bags 148a and 148b are shown for mounting in between the arms of the luggage handle frame 132 while more or less small bags could be used. In this view, bag 148b is a laptop bag and the other bag 148a is a small carry bag. FIG. 2 is a perspective view of the entire piece of luggage shown in FIG. 1, in this view, also showing wheels 150.

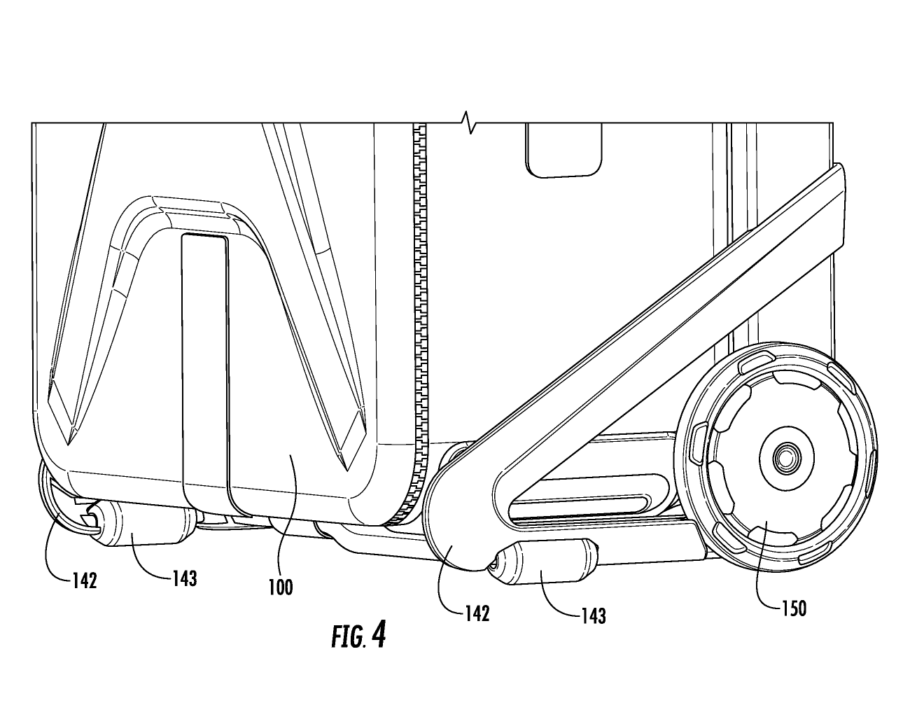

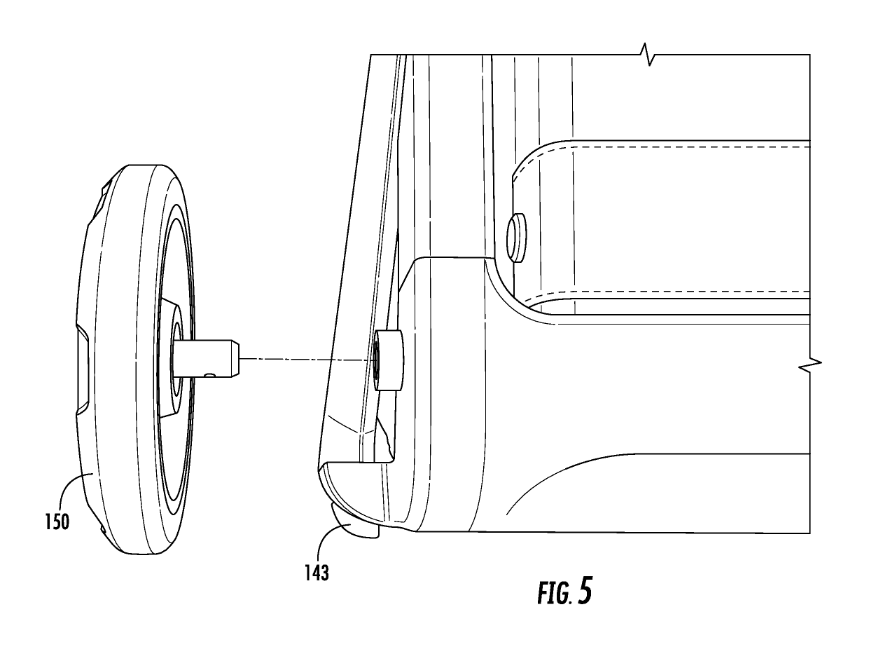

FIG. 3 shows the luggage of the invention sitting on a conveyor roller. In this view, the pivot frame 130 has been pivoted such that the case and pivot frame are both flat on the roller. In this perspective view, the laptop can easily be viewed by security. FIG. 4 is a close up of the bottom of the luggage clearly showing the feet 142 and perpendicular wheels 143 as well as regular wheels 150. In this embodiment, the wheels 143 and 150 are all removable and replaceable with quick release or otherwise. FIG. 5 shows a quick release of regular wheel 150.

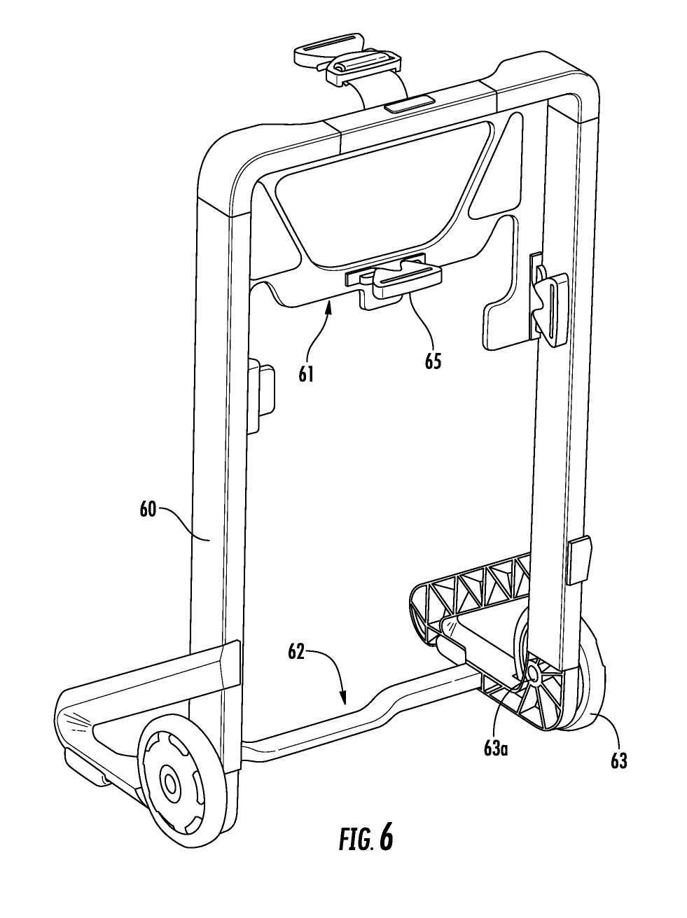

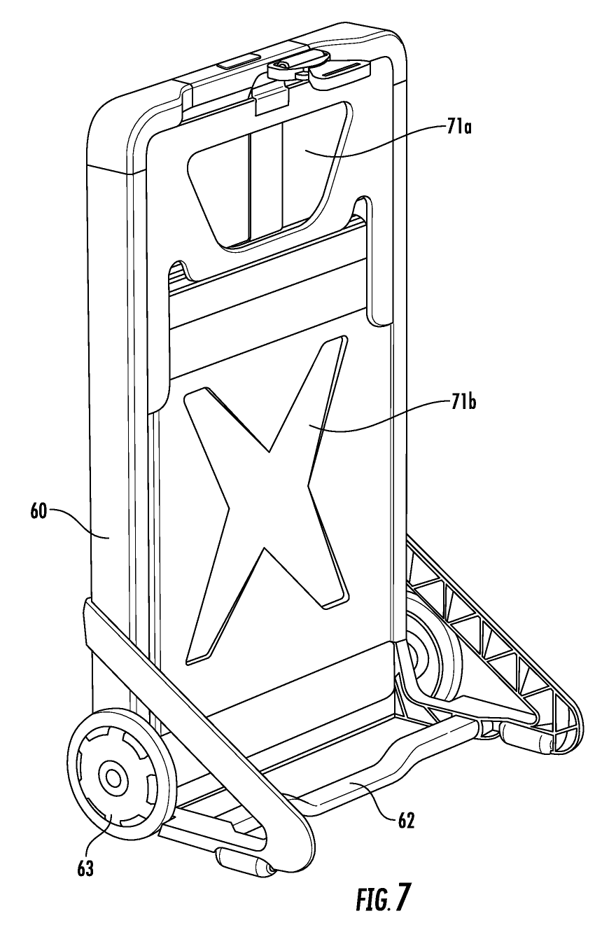

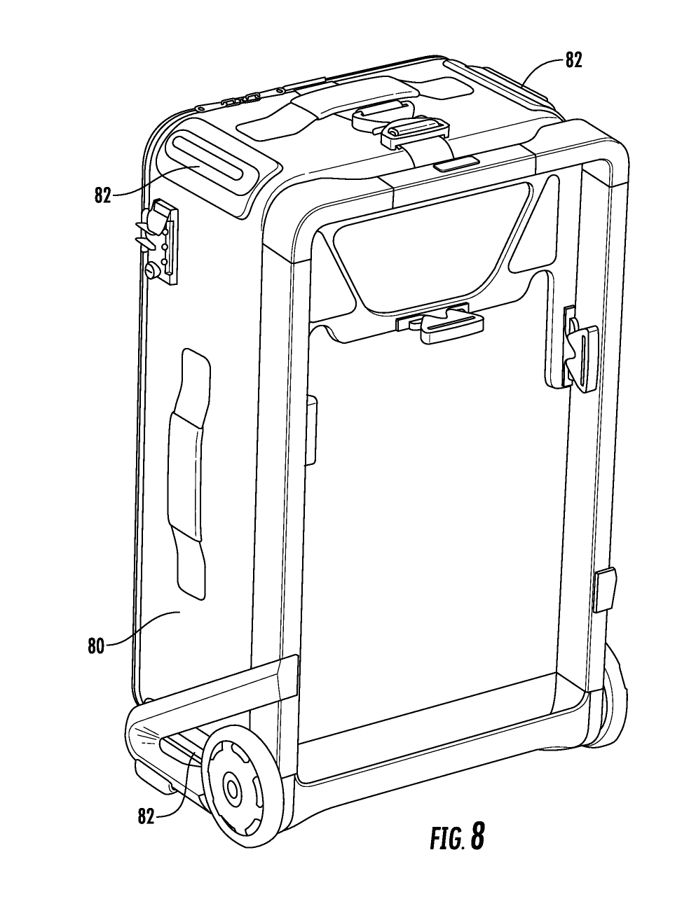

FIGS. 6, 7, and 8 show alternate embodiments of the invention. FIG. 6 is a perspective view of a pivot frame 60. In this view, a handle or grab bar 62 is clearly shown. Wheels 63 fit into race 63a. Connector 65 is shown on connection panel 61 for connecting bags. FIG. 7 is a perspective view of the pivot frame 60 when two bags 71a and 71b are shown. Bag 71b is a laptop bag. FIG. 8 is a perspective view of the frame 60 with an attached case 80 in a pivotal manner. It is shown without the cases of FIG. 7. In this view, corner covers 82 cover the bags corners.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A luggage article having a case portion having a backside, opposing front panel, and four corners comprising a pivotable frame pivotally connected to the case portion comprising:
a) a pivot frame connection panel;
b) main wheels mounted on a wheel assembly;
c) a collapsible two-arm luggage handle and two-arm luggage handle frame; and
d) one or more removable small bags mounted in between the two-arm luggage handle frame.

2. The luggage article according to claim 1 wherein there are wheels or slides mounted to operate in a direction perpendicular to a direction of the main wheels mounted on the wheel assembly.

3. The luggage article according to claim 1 wherein the pivotal frame pivots by a wheel assembly axle mounted pivotally on a bottom side of the case portion.

4. The luggage article according to claim 1 wherein the wheels are quick release type wheels.

5. The luggage article according to claim 1 wherein one of the small bags mounted in between the two-arm luggage handle frame is a laptop bag.

6. The luggage article according to claim 1 wherein the pivotal frame further comprises rigid feet for aiding in standing the luggage on a bottom.

7. The luggage article according to claim 1 wherein the case portion has a rigid single piece external back panel mounted on the case backside.

8. The luggage article according to claim 1 wherein the pivot frame connection panel can removably lock against the case portion or an external back panel.

9. The luggage article according to claim 1 wherein when the case front panel is laying on a flat surface, the pivotal frame can pivot and lay flat on the same flat surface.

10. The luggage article according to claim 1 wherein there are rigid coverings on the case 4 corners.
